(19) United States
(12) Patent Application Publication
(10) Pub. No.: US 2019/0320220 A1
(43) Pub. Date: Oct. 17, 2019

(54) Set-Top Box with Enhanced Content and System and Method for Use of Same

(71) Applicant: Enseo, Inc., Richardson, TX (US)

(72) Inventors: Vanessa Ogle, Fairview, TX (US); William C. Fang, Plano, TX (US)

(21) Appl. No.: 16/384,725

(22) Filed: Apr. 15, 2019

Related U.S. Application Data
(60) Provisional application No. 62/657,237, filed on Apr. 13, 2018.

(51) Int. Cl. H04N 21/4363; H04N 21/43; H04N 21/439; H04N 21/44; H04N 21/8545

(52) U.S. Cl. CPC H04N 21/43637; H04N 21/4302; H04N 21/8545; H04N 21/44; H04N 21/439

(57) ABSTRACT

A set-top box with enhanced content and system and method for use of the same are disclosed. In one embodiment of the set-top box, a wireless communication antenna is located within a housing, which also interconnectively includes a signal input, a signal output, a processor, and memory. The set-top box provides a fully tuned audiovisual signal to a display or a television, for example, by way of the signal output. A wireless signal having the audio component of the fully tuned audiovisual signal is transmitted via the wireless communication antenna using a network connection protocol, such as a Bluetooth protocol. A proximate wireless-enabled interactive programmable device may receive the wireless signal to render the audio component of the fully tuned audiovisual signal at the proximate wireless-enabled interactive programmable device.

### PRIORITY STATEMENT & CROSS-REFERENCE TO RELATED APPLICATION

This application claims priority from co-pending U.S. Patent Application Ser. No. 62/657,237 entitled “Set-Top Box with Enhanced Content and System and Method for Use of Same” filed on Apr. 13, 2018, in the names of William C. Fang and Vanessa Ogle; which is hereby incorporated by reference for all purposes.

### TECHNICAL FIELD OF THE INVENTION

This invention relates, in general, to set-top boxes and, in particular, to set-top boxes with enhanced content and systems and methods for use of the same that address and enhance the content provided to a display or television, for example.

### BACKGROUND OF THE INVENTION

Without limiting the scope of the present invention, the background will be described in relation to televisions in the service industry, as an example. To many individuals, a television is more than just a display screen, rather it is a doorway to the world, both real and imaginary, and a way to experience new possibilities and discoveries. As such, a television is a focal point for consumers and consumers are demanding enhanced content in an easy-to-use platform. As a result of such consumer preferences, the quality of content and ease-of-use are frequent differentiators in determining the experience of consumers in the service industry at such places as sports bars and gymnasiums. Accordingly, there is a need for improved systems and methods for providing enhanced content in an easy-to-use platform in the service industry.

### SUMMARY OF THE INVENTION

It would be advantageous to achieve a set-top box that would improve upon existing limitations in functionality. It would also be desirable to enable a computer-based electronics and software solution that would provide enhanced content in an easy-to-use platform in the service industry or in another environment. To better address one or more of these concerns, a set-top box with enhanced content and system and method for use of the same are disclosed. In one embodiment of the set-top box, a wireless communication antenna is located within a housing, which also interconnectively includes a signal input, a signal output, a processor, and memory.

The set-top box provides a fully tuned audiovisual signal to a display or a television, for example, by way of the signal output. A wireless signal having the audio component of the fully tuned audiovisual signal is transmitted via the wireless communication antenna using a network connection protocol, such as a Bluetooth protocol. A proximate wireless-enabled interactive programmable device may receive the wireless signal to render the audio component of the fully tuned audiovisual signal at the proximate wireless-enabled interactive programmable device. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing a set-top box having enhanced content thereon according to the teachings presented herein;

FIG. 2A is a wall-facing exterior elevation view of one embodiment of the set-top box depicted in FIG. 1 in further detail;

FIG. 2B is a display-facing exterior elevation view of the set-top box depicted in FIG. 1;

FIG. 2C is a front perspective view of a dongle depicted in FIG. 1 in further detail;

FIG. 3 is a functional block diagram depicting one embodiment of the set-top box presented in FIGS. 3A and 3B;

FIG. 4 is a signalization timing depicting one embodiment of an operational process furnishing enhanced content according to the teachings presented herein; and

FIG. 5 is a flow chart depicting one embodiment of a method for providing a set-top box having enhanced content thereon according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

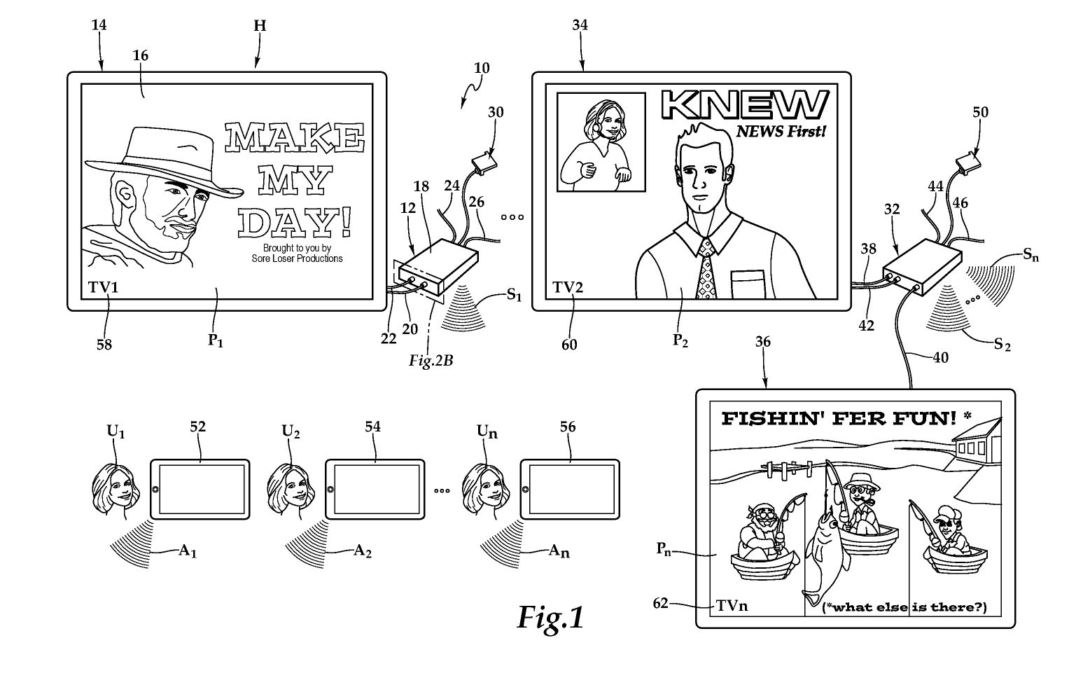

Referring initially to FIG. 1, therein is depicted one embodiment of a system 10 utilizing set-top box 12 with enhanced content capabilities being employed within a service industry establishment, such as a sports bar or gymnasium, for example. As shown, in one embodiment, the system 10 includes the set-top box 12 and the display 14, which is illustrated as a television having a screen 16. It should be appreciated however, that the display 14 may also be any electronic visual display device, for example. A connection, which is depicted as an HDMI connection 20, connects the set-top box 12 to the display 14. Other connections include a power cable 22 coupling the set-top box 12 to a power source, a coaxial cable 24 coupling the set-top box 12 to an external cable source, and a category five (Cat 5) cable 26 coupling the set-top box 12 to an external pay-per-view source, for example. As shown, the set-top box 12 may include a dongle 30 providing particular technology and functionality extensions thereto. That is, the set-top box 12 may be set-top box-dongle combination in one embodiment. More generally, it should be appreciated that the cabling connected to the set-top box 12 will depend on the environment and application, and the cabling connections presented in FIG. 1 are depicted for illustrative purposes. Further, it should be appreciated that the positioning of the set-top box 12 will vary depending on environment and application and, with certain functionality, the set-top box 12 may be placed more discretely behind the display 14.

The system 10 also includes a set-top box 32, a display 34 and a display 36. A connection, which is depicted as an HDMI connection 38, connects the set-top box to the display 34. Similarly, a connection, which is depicted as an HDMI connection 40, connects the set-top box to the display 36. Other connections include a power cable 42 coupling the set-top box 32 to a power source, a coaxial cable 44 coupling the set-top box 32 to an external cable source, and a category five (Cat 5) cable 46 coupling the set-top box 32 to an external pay-per-view source, for example. As shown, the set-top box 32 may include a dongle providing particular technology and functionality extensions thereto. It should be appreciated that depending on the configuration of the set-top box, such as the set-top box 12 or the set-top box 32, each of the set-top boxes may support one or more displays.

Proximate wireless-enabled interactive programmable devices 52, 54, 56 may each be a device, including handheld devices, that may be supplied or carried by the consumer, for example, and may be selected from a range of existing devices, such as, for example, personal computers, laptops, tablet computers, smart phones, smart watches, and smart speakers, for example. As depicted in FIG. 1, a program P1 is showing on the display 14 and the signal for the program P1 is provided by the set-top box 12. Similarly, a program P2 is showing on the display 34 and a program Pn is being shown on the display 36. The signal for each of the programs P2 and Pn is provided by the set-top box 32. Each of the proximate wireless-enabled interactive programmable devices may receive a wireless signal, such as signals S1, S2, . . . , Sn, where signals S1 is transmitted by the set-top box 12 and the signals S2 . . . Sn are transmitted by the set-top box 32. Each of the wireless signals S1, S2, . . . , Sn, represents the audio component of the respective fully tuned audiovisual signal furnishing programs P1, P2, . . . Pn. Network connection identifications 58, 60, 62 are provided at each of the displays 14, 34, 36. As shown, the network connection identifications 58, 60, 62 may be displayed on the display as shown by network connection identification 58 being shown on the display 14. In this instance, the network connection identification 58 may be provided by the set-top box 12 via a signal output therefrom. In another instance, the network connection identifications 58, 60, 62 may be displayed proximate the display as shown with the network connection identifications 60, 62 at the displays 34, 36 where, as an exemplary implementation, small placards on frames of the displays 34, 36 show the network connection identifications.

A user having the proximate wireless-enabled interactive programmable device 52 may receive the audio component of the fully tuned audiovisual signal provided by the set-top boxes 12, 32 to any one of the displays 14, 34, 36 by utilizing the network connection identifications 58, 60, 62 in conjunction with a network connection protocol, such as a wireless protocol, for example. The user utilizes the network connection identification corresponding to the program the user wishes to watch. By way of example, the user of the proximate wireless-enabled interactive programmable device 52 is in a service environment, such as a bar or gymnasium, and the individual desires to listen to the program P₁. The user U₁ utilizes the network connection identification 58 to receive the wireless signal S₁ and receive the audio component of the fully tuned audiovisual signal provided to the display 16 showing program P₁. The user U₁ may then utilize speakers or headphones associated with the proximate wireless-enabled interactive programmable device 52 to furnish the synchronized audio content of program P₁. The audio component is then played as audio A₁. Similarly, the user U₂ utilizes the network connection identification 60 to receive the wireless signal S₂ and receive the audio component of the fully tuned audiovisual signal provided to the display 34 showing program P₂. The audio component is then played as audio A₂. The user Uₙ utilizes the network connection identification 62 to receive the wireless signal Sₙ and receive the audio component of the fully tuned audiovisual signal provided to the display 36 showing program Pₙ. The audio component is then played as audio Aₙ.

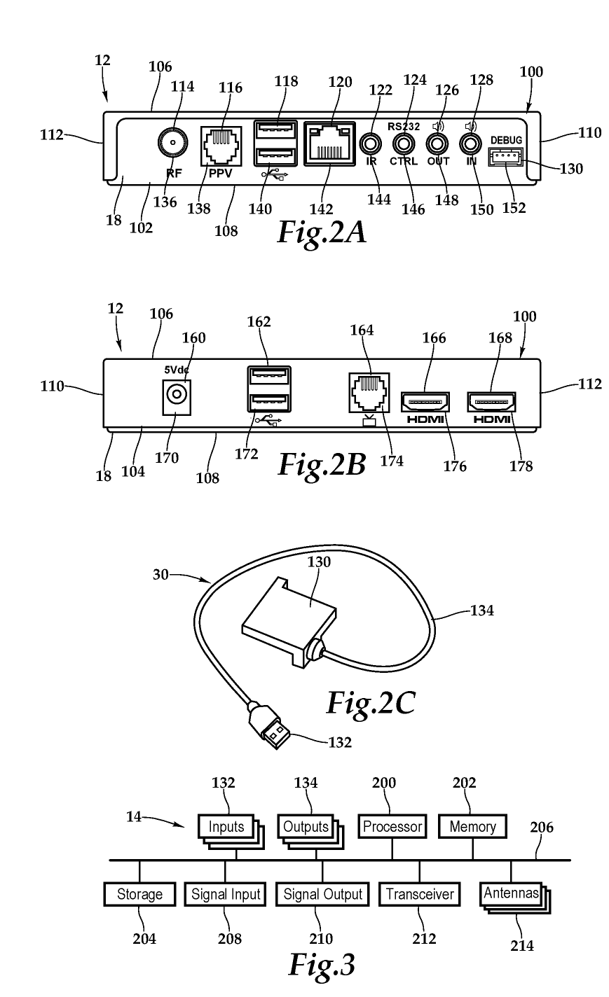

Referring to FIG. 2A, FIG. 2B, FIG. 2C, and FIG. 3, as used herein, set-top boxes, back boxes and set-top/back boxes may be discussed as set-top boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 12 includes a housing 18 including a panel 100 and a rear wall 102, front wall 104, top wall 106, bottom base 108, and two sidewalls 110, 112. It should be appreciated that front wall, rear wall, and side wall are relative terms used for descriptive purposes and the orientation and the nomenclature of the walls may vary depending on application. The front wall includes various ports, ports 114, 116, 118, 120, 122, 124, 126, 128 and 130 that provide interfaces for various interfaces, including inputs 132 and outputs 134. In one implementation, as illustrated, the ports 114 through 130 include inputs 132 and outputs 134 and, more particularly, an RF input 136, a RJ-45 input 138, universal serial bus (USB) input/outputs 140, an Ethernet category 5 (Cat 5) coupling 142, an internal reset 144, an RS232 control 146, an audio out 148, an audio in 150, and a debug/maintenance port 152. The front wall 104 also includes various inputs 132 and outputs 134. More particularly, ports 160, 162, 164, 166, 168 include a 5V dc power connection 170, USB inputs/outputs 172, an RJ-45 coupling 174, an HDMI port 176 and an HDMI port 178. It should be appreciated that the configuration of ports may vary with the set-top box depending on application and context. As previously alluded to, the housing 18 may include a housing-dongle combination including, with respect to the dongle 30, a unit 180 having a cable 182 with a set-top box connector 184 for selectively coupling with the set-top box 12.

Within the housing 18, a processor 200, memory 202, storage 204, the inputs 132, and the outputs 134 are interconnected by a bus architecture 206 within a mounting architecture. It should be understood that the processor 200, the memory 202, the storage 204, the inputs 132, and the outputs 134 may be entirely contained within the housing 18 or the housing-dongle combination. The processor 200 may process instructions for execution within the computing device, including instructions stored in the memory 202 or in storage 204. The memory 202 stores information within the computing device. In one implementation, the memory 202 is a volatile memory unit or units. In another implementation, the memory 202 is a non-volatile memory unit or units. Storage 204 provides capacity that is capable of providing mass storage for the set-top box 12. Various inputs 132 and outputs 134 provide connections to and from the computing device, wherein the inputs 132 are the signals or data received by the set-top box 12, and the outputs 134 are the signals or data sent from the set-top box 12. A television content signal input 208 and a television output 210 are also secured in the housing 18 in order to receive content from a source and forward the content, including external content such as cable and satellite and pay-per-view (PPV) programming, to the display.

A transceiver 212 is associated with the set-top box 12 and communicatively disposed with the bus 206. As shown the transceiver 212 may be internal, external, or a combination thereof to the housing 18. Further, the transceiver 212 may be a transmitter/receiver, receiver, or an antenna for example. Communication between various devices and the set-top box 12 may be enabled by a variety of wireless methodologies employed by the transceiver 212, including 802.11, 3G, 4G, Edge, WiFi, ZigBee, near field communications (NFC), Bluetooth low energy and Bluetooth, for example. Also, infrared (IR) may be utilized.

One or more wireless communication antennas 214 are associated with the set-top box 12 and communicatively disposed with the bus 206. As shown the wireless communication antenna 214 may be internal, external, or a combination thereof to the housing 18. Further, the wireless communication antenna 214 may be a transmitter/receiver, receiver, or an antenna for example. Communication from the set-top box 12 to one or more of the proximate wireless-enabled programmable interactive devices 52, 54, 56 may be enabled by a variety of wireless methodologies employed by the wireless communication antennas 214, including 802.11, 3G, 4G, Edge, WiFi, ZigBee, near field communications (NFC), Bluetooth low energy and Bluetooth, for example. Also, infrared (IR) may be utilized. In one implementation, the one or more wireless communication antennas 214 utilize a network connection protocol such as Bluetooth and the one or more wireless communication antennas 214 are WiFi transmitters.

The memory 202 and storage 204 are accessible to the processor 200 and include processor-executable instructions that, when executed, cause the processor 200 to execute a series of operations. The processor-executable instructions cause the processor to receive a source signal from the external source and then generate a fully tuned audiovisual signal from the source signal. Also, the processor-executable instructions cause the processor to generate a wireless signal having the audio component of the fully tuned audiovisual signal. The fully tuned audiovisual signal is caused by the instructions to be forwarded to the display via the signal output the wireless signal is caused to be transmitted by the instructions via the wireless communication antenna using a network connection protocol. The processor-executable instructions that, when executed, specify a search operation to identify the proximate wireless-enabled interactive programmable device, wherein the search operation utilizes the wireless communication antenna to wirelessly identify the proximate wireless-enabled interactive programmable device.

In set-top box configurations, like set-top box 32, with multiple signal outputs and multiple wireless communication antennas, the processor-executable instructions may also include instructions that, when executed, cause a processor to generate a second fully tuned audiovisual signal from the source signal and generate a second wireless signal having a second audio component of the second fully tuned audiovisual signal. The processor-executable instructions may also cause the processor to forward the second fully tuned audiovisual signal to a second display via the second signal output, and transmit the second wireless signal via the second wireless communication antenna using the network connection protocol.

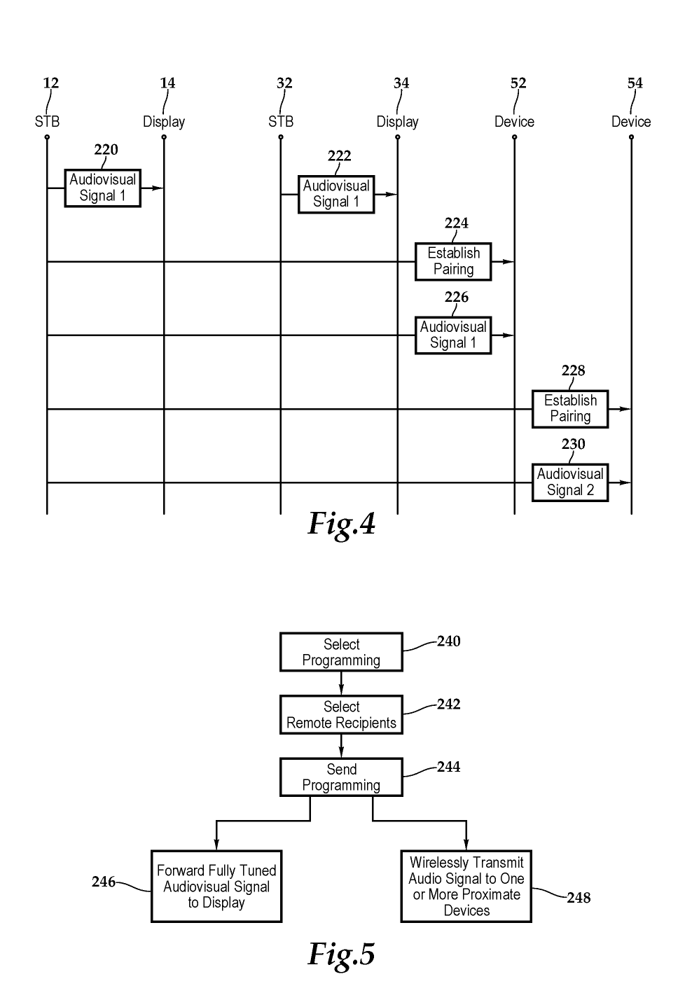

Referring now to FIG. 4, wherein signalization timing between the set-top box 12, the display 14, the set-top box 32, the display 34, the proximate wireless-enabled programmable interactive device 52, and the proximate wireless-enabled programmable interactive device 54 is depicted. At signaling block 220, a fully tuned audiovisual signal containing programming is forwarded from the set-top box 12 to the display 14. Similarly, at signaling block 222, a fully tuned audiovisual signal containing programming is forwarded from the set-top box 32 to the display 34. At signaling block 224, a proximate wireless enabled interactive programmable device 52 establishes a pairing with the set-top box 12 by subscribing to a network communication protocol, such as one of the aforementioned wireless protocols. As a result, at signaling block 226, an audio signal is wirelessly sent from the set-top box 12 and received at the proximate wireless enabled interactive programmable device 52. The audio signal includes the audio component of the fully tuned audiovisual signal provided at signaling block 220. At signaling block 228, a proximate wireless enabled interactive programmable device 54 establishes a pairing with the set-top box 32 by subscribing to a network communication protocol, such as Bluetooth. As a result, at signaling block 230, an audio signal is wirelessly sent from the set-top box 32 and received at the proximate wireless enabled interactive programmable device 54. The audio signal includes the audio component of the fully tuned audiovisual signal provided at signaling block 222.

FIG. 5 depicts one embodiment of a method for providing enhanced content, according to the teachings presented herein. The methodology may be implemented by a set-top box, such as the set-top box 12 presented in FIG. 1 through FIG. 3. The method may begin at block 240 where programming is selected by choosing, for example, content received at the set-top box 12. At block 242, remote recipients are selected. Remote recipients generally refer to other devices, such as proximate wireless-enabled interactive programmable devices, that are capable of receiving the selected programming from the set-top box 12. In one implementation, networking is utilized whereby the programming is transmitted to one or more unique addresses or the programming is subscribed to by other devices. Following block 242, the methodology proceeds to block 244 where the programming is transmitted. As shown at block 246, this includes forwarding a fully tuned audiovisual signal to a display and, at block 248, wirelessly transmitting the audio signal to one or more wireless recipients. As previously discussed, the audio signal is the audio component of the fully tuned audiovisual signal provided to the display.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box comprising:
a housing securing a signal input, a signal output, a processor, memory, and storage therein;
a busing architecture communicatively interconnecting the signal input, the signal output, the processor, the memory, and the storage;
a wireless communication antenna associated with the housing and coupled to the busing architecture, the wireless communication antenna configured to send a wireless signal to a proximate wireless-enabled interactive programmable device;
the signal input configured to receive a source signal from an external source;
the signal output configured to forward a fully tuned audiovisual signal to a display; and
the memory accessible to the processor, the memory including processor-executable instructions that, when executed, cause the processor to:
receive a source signal from the external source,
generate the fully tuned audiovisual signal from the source signal,
generate a wireless signal having the audio component of the fully tuned audiovisual signal,
forward the fully tuned audiovisual signal to the display via the signal output, and
transmit the wireless signal via the wireless communication antenna using a network connection protocol.

2. The set-top box as recited in claim 1, wherein the wireless communication antenna further comprises a WiFi transmitter.

3. The set-top box as recited in claim 1, wherein the network connection protocol further comprises a WiFi protocol.

4. The set-top box as recited in claim 1, wherein the wireless signal is synchronized with the fully tuned audiovisual signal.

5. The set-top box as recited in claim 1, further comprising a network connection identification visible at the display, the network connection identification enabling the proximate wireless-enabled interactive programmable device to subscribe to the wireless signal.

6. The set-top box as recited in claim 1, wherein the memory further comprises processor-executable instructions that, when executed, forward a network connection identification for display on the display via the signal output, the network connection identification enabling the proximate wireless-enabled interactive programmable device to subscribe to the wireless signal.

7. The set-top box as recited in claim 1, further comprising:
a second signal output secured within the housing, the second signal output being communicatively interconnected with the busing architecture; and
a second wireless communication antenna associated with the housing and coupled to the busing architecture, the second wireless communication antenna configured to send a second wireless signal to a second proximate wireless-enabled interactive programmable device.

8. The set-top box as recited in claim 7, wherein the memory further comprises processor-executable instructions that, when executed, cause the processor to:
generate a second fully tuned audiovisual signal from the source signal;
generate a second wireless signal having a second audio component of the second fully tuned audiovisual signal;
forward the second fully tuned audiovisual signal to a second display via the second signal output; and
transmit the second wireless signal via the second wireless communication antenna using the network connection protocol.

9. The set-top box as recited in claim 1, wherein the memory further comprises processor-executable instructions that, when executed, specify a search operation to identify the proximate wireless-enabled interactive programmable device, wherein the search operation utilizes the wireless communication antenna to wirelessly identify the proximate wireless-enabled interactive programmable device.

10. The set-top box as recited in claim 1, wherein the wireless communication antenna is at least partially positioned outside of the housing.

11. The set-top box as recited in claim 1, wherein the wireless communication antenna is at least partially positioned inside of the housing.

12. The set-top box as recited in claim 1, wherein the housing further comprises a housing-dongle combination securing the signal input, the signal output, the processor, memory, storage, and wireless communication antenna therewith.

13. The set-top box as recited in claim 12, wherein the processor and the memory are distributed through the housing-dongle combination.

14. The set-top box as recited in claim 12, wherein the wireless communication antenna is at least partially located in a dongle portion of the housing-dongle combination.

15. The set-top box as recited in claim 1, further comprising a wireless transceiver associated with the housing and coupled to the busing architecture.

16. The set-top box as recited in claim 15, wherein the wireless transceiver is configured to communicate with the proximate wireless-enabled interactive programmable device via a standard selected from the group consisting of infrared (IR), 802.11, 3G, 4G, Edge, Wi-Fi, ZigBee, near field communications (NFC), Bluetooth, and Bluetooth low energy.

17. The set-top box as recited in claim 1, wherein the display further comprises a device selected from the group consisting of electronic visual display devices and televisions.

18. The set-top box as recited in claim 1, wherein the proximate wireless-enabled interactive programmable device comprises a device selected from the group consisting of personal computers, laptops, tablet computers, smart phones, smart watches, and smart speakers.

19. A set-top box comprising:
a housing securing a signal input, a signal output, a processor, memory, and storage therein;
a busing architecture communicatively interconnecting the signal input, the signal output, the processor, the memory, and the storage;
a wireless communication antenna associated with the housing and coupled to the busing architecture, the wireless communication antenna being a WiFi transmitter, the wireless communication antenna configured to send a wireless signal to a proximate wireless-enabled interactive programmable device;
the signal input configured to receive a source signal from an external source;
the signal output configured to forward a fully tuned audiovisual signal to a display;
a network connection identification visible at the display, the network connection identification enabling the proximate wireless-enabled interactive programmable device to subscribe to the wireless signal; and
the memory accessible to the processor, the memory including processor-executable instructions that, when executed, cause the processor to:
receive a source signal from the external source,
generate the fully tuned audiovisual signal from the source signal,
generate a wireless signal having the audio component of the fully tuned audiovisual signal,
forward the fully tuned audiovisual signal to the display via the signal output, and
transmit the wireless signal via the wireless communication antenna using a Bluetooth network connection protocol.

20. A set-top box system comprising:
first and second set-top boxes each comprising:
a housing securing a signal input, a signal output, a processor, memory, and storage therein;
a busing architecture communicatively interconnecting the signal input, the signal output, the processor, the memory, and the storage;
a wireless communication antenna associated with the housing and coupled to the busing architecture, the wireless communication antenna being a WiFi transmitter, the wireless communication antenna configured to send a wireless signal to a proximate wireless-enabled interactive programmable device;
the signal input configured to receive a source signal from an external source;
the signal output configured to forward a fully tuned audiovisual signal to a display;
a network connection identification visible at the display, the network connection identification enabling the proximate wireless-enabled interactive programmable device to subscribe to the wireless signal; and
the memory accessible to the processor, the memory including processor-executable instructions that, when executed, cause the processor to:
receive a source signal from the external source,
generate the fully tuned audiovisual signal from the source signal,
generate a wireless signal having the audio component of the fully tuned audiovisual signal,
forward the fully tuned audiovisual signal to the display via the signal output, and
transmit the wireless signal via the wireless communication antenna using a Bluetooth network connection protocol; and
the respective network connection identifications of the first and second set-top boxes being different.
